(19) United States
(12) Patent Application Publication
(10) Pub. No.: US 2012/0232833 A1
(43) Pub. Date: Sep. 13, 2012

(54) METHOD AND SYSTEM FOR MONITORING A THIN STRUCTURE

(75) Inventors: Franco Simi, Mestre (VE) (IT); Antonio Agosti, Foggia (IT); Paolo Bosetti, Trento (IT); Giorgio Parzianello, Trento (IT)

(73) Assignees: VODAFONE OMNITEL N.V., Amsterdam (NL); VODAFONE GROUP PLC, Newbury (GB)

(21) Appl. No.: 13/384,566

(22) PCT Filed: Jul. 19, 2010
(86) PCT No.: PCT/IB2010/001750

§ 371 Date: May 30, 2012

(30) Foreign Application Priority Data
Jul. 17, 2009 (IT) MI2009A001272

(51) Int. Cl. G06F 15/00; G01P 15/00

(52) U.S. Cl. 702/141

(57) ABSTRACT

A method and a system for monitoring a thin structure foresee acquiring the acceleration signals emitted by a plurality of accelerometers associated with the structure, obtaining the frequency spectrum of such signals, detecting their frequency peaks and temporal variations to calculate, for each of the frequency peaks, an average value and a statistical value that define a range of frequency values. Subsequently, at predetermined time periods, the frequency peaks are detected and, with respect to each average value, it is verified whether the corresponding peak frequency is outside of the respective range of frequency values and an error signal is generated as a function of such verification. In this case, the error signal and the processed signals of the accelerometers are sent to a remote unit where the signals are analysed to determine the state of the structure and its past data and to evaluate whether it is necessary for it to have technical personnel intervention.

The present invention concerns a method and a system for monitoring a thin structure.

In particular, the present invention refers to a method and a system for monitoring a thin structure with constant mass over time and having a first free end and a second opposite end rigidly constrained to a stationary base element.

Structures of the aforementioned type can be, for example, a pole or an antenna-carrying trellis, a lighthouse or a pole for wind turbines, a pole or trellis for lighting systems, and the like.

As it is known, such structures are dynamically stressed by wind action and by fatigue stress, for example by the rotary movement of the wind turbines. Over time, the dynamic action of the wind on the structure can determine unexpected fatigue-breaking. In particular, the presence of structural defects can determine, in certain conditions, formation of fracture lines, cracking on the welding and on other mobile parts of the structure, causing there to be a decrease of the rigidity of the structure with consequent reduction of its actual frequencies.

It is also useful to indicate the existence of other factors, apart from wind, such as ice, climbing of technical maintenance personnel, which do not determine fatigue on the structure but still stress it. Such factors, although they do not jeopardise the structure, determine an anomaly on the actual frequencies of such a structure.

In the state of the art, ad hoc monitoring solutions are known for single civil structures, where an operator watches over the structure and verifies, on the field, the state of the structure and the possible formation of cracks/fracture lines.

The aforementioned solutions are however unsuitable when there is a high number of structures to be monitored. In particular, the aforementioned solutions are unsuitable when it is necessary to simultaneously monitor a plurality of structures, even arranged in locations far from one another. For example, the aforementioned solutions cannot be applied to monitoring systems of antenna-carrying poles/trestles for mobile telephone communications, where the poles to be monitored cover substantially large areas. In this case, the use of an operator for each pole/trestle would be unacceptable with respect to the low management cost requirements that such systems must be able to satisfy.

The aim of the present invention is to provide a method and a system that make it possible to monitor a thin structure with low management costs while still maintaining a high efficiency in identifying possible cracks and fracture lines in the structure.

This aim is achieved with a method for monitoring a thin structure according to claim 1.

In accordance with a further aspect, this aim is achieved with a system for monitoring a thin structure according to claim 6.

In accordance with one embodiment, the method and the system foresee acquiring the acceleration signals emitted by the accelerometers applied to the structure, detecting the frequency peaks of such signals, processing the temporal variations of the peak frequencies to calculate their average and statistical reference values, verifying whether the peak frequencies, detected over successive time periods, are outside the statistical reference value and generating an error signal according to such a verification.

With respect to a common technique based upon a threshold indicator, based upon a predefined and arbitrary choice, the application of a statistical technique of calculating the average and statistical reference values of the peak frequencies makes it possible to identify, based upon the intrinsic variance of the acquired values, the width of the reference range inside which the measured peak frequencies can be considered “statistically stable”. Such a technique can therefore be applied for simultaneously monitoring a high number of structures, like for example in the case of systems for antenna-carrying poles/trestles for mobile telephone communications and poles for wind turbines.

Further characteristics and advantages of the method and of the system according to the present invention shall become clearer from the following description of a preferred embodiment, given for indicating and not for limiting purposes, with reference to the attached figures in which:

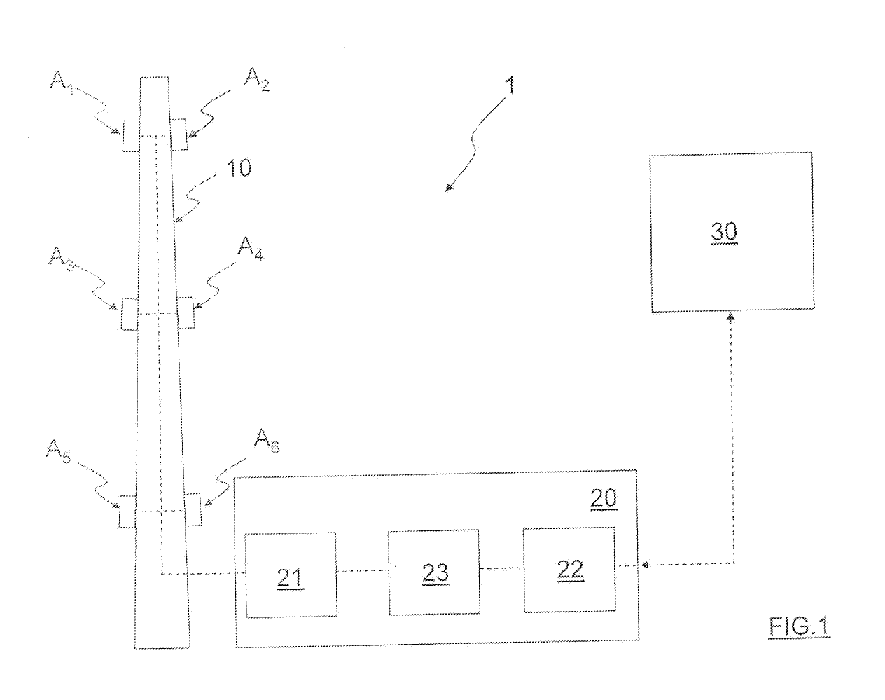

FIG. 1 shows a system for monitoring a thin structure in accordance with the present invention,

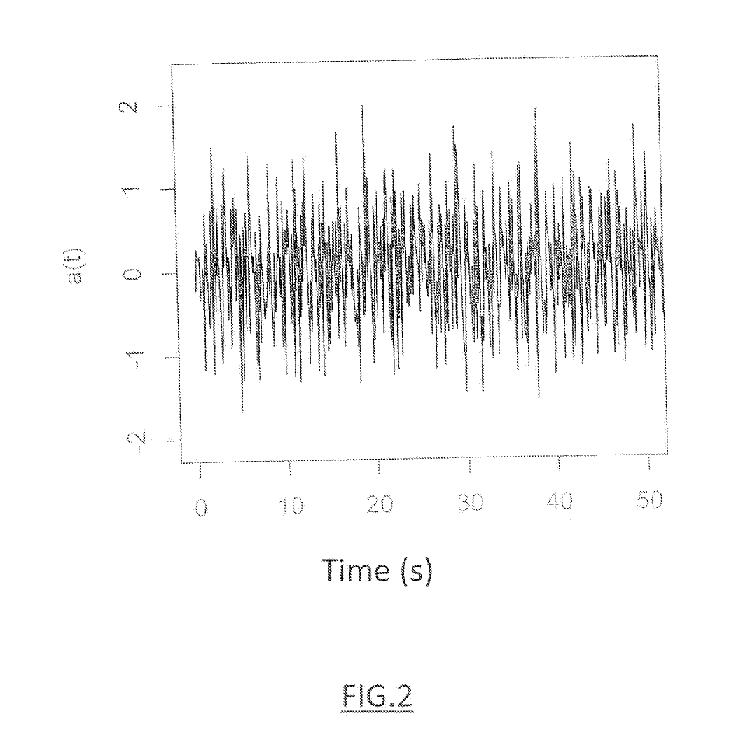

FIG. 2 shows an acceleration signal emitted by an accelerometer of FIG. 1,

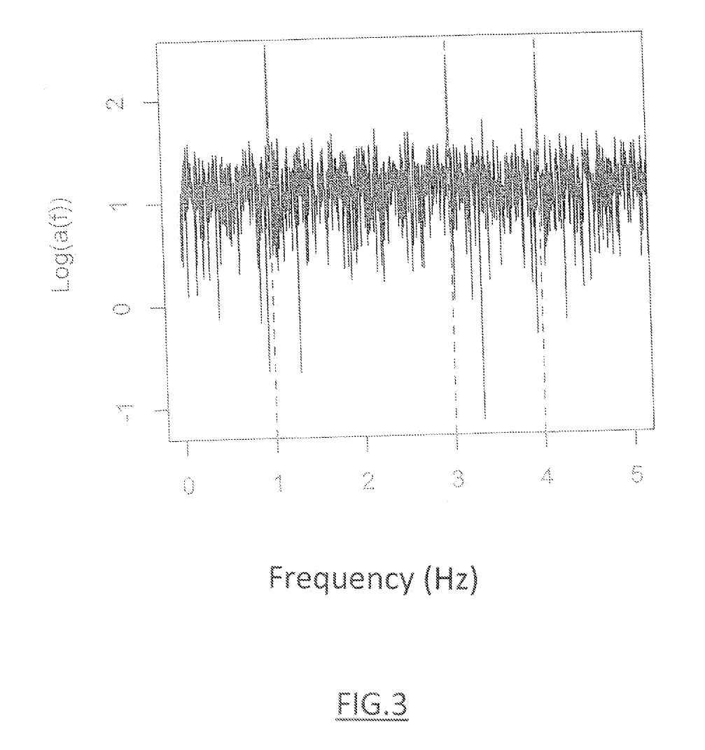

FIG. 3 shows the frequency signal of the signal of FIG. 2 with the frequency peaks,

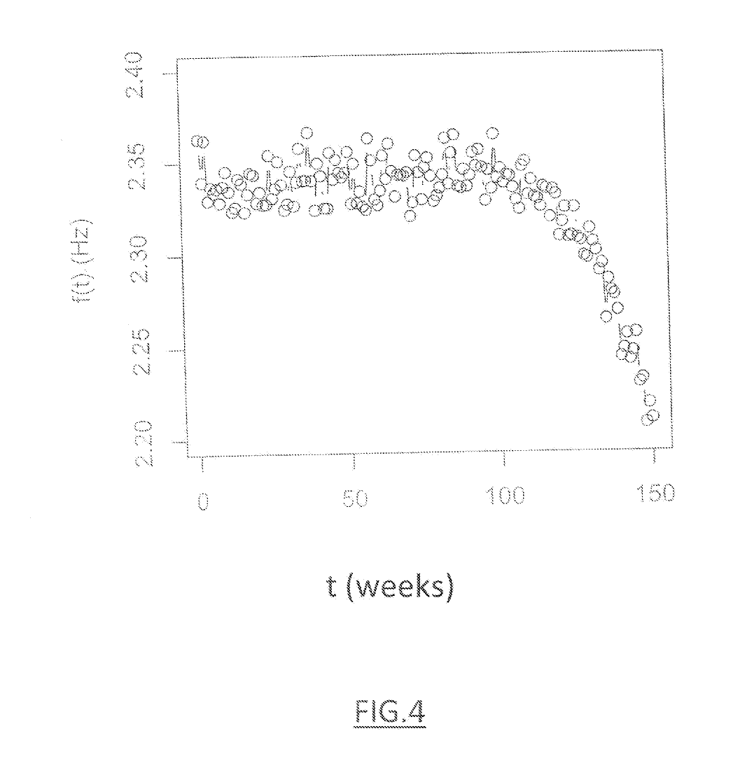

FIG. 4 shows the temporal evolution of a peak frequency of the signal of FIG. 3,

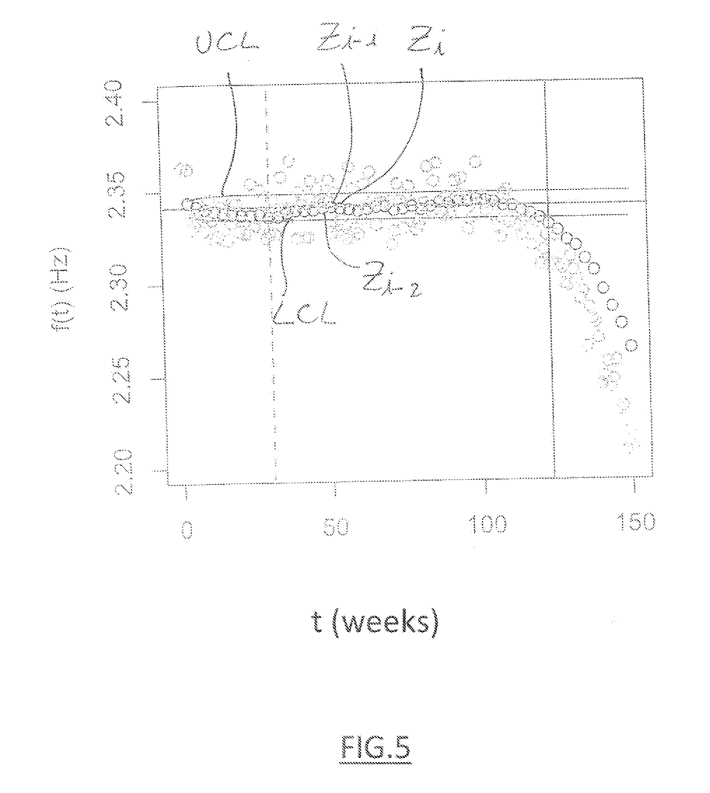

FIG. 5 shows an Exponentially Weighted Moving Average (EWMA) chart obtained from the signal of FIG. 4.

With reference to FIG. 1, reference numeral 1 globally indicates a system for monitoring a thin structure 10, having a constant mass M over time and having a first free end 10a and a second opposite end 10b rigidly constrained to a stationary base element 11, representing the foot of structure 10.

Structure 10 for example can be a pole or an antenna-carrying trellis, a lighthouse, a pole for wind turbines, a pole for lighting systems and the like, dynamically stressed by wind action.

To structure 10, a plurality N of accelerometers Aₙ, with n=1 . . . N is associated.

Each accelerometer Aₙ is suitable for emitting an acceleration signal aₙ(t) representative of the acceleration detected by the accelerometer itself.

In particular, each accelerometer Aₙ detects the values of the two acceleration components aₓ, a_{y} respectively on the axes X and Y and converts such components into an acceleration signal with magnitude a and phase φ, where a represents the intensity of the detected acceleration and the step φ represents the angle of the direction of maximum acceleration.

In accordance with one embodiment, accelerometers Aₙ comprise accelerometers MEMS fixed to structure 10 in suitable positions, selected so as to amplify the width of the oscillations of structure 10 itself.

Accelerometers Aₙ are in signal communication with an acquisition and processing unit 20.

Acquisition and processing unit 20 comprises a signal input interface 21 coupled with accelerometers Aₙ to receive the acceleration signals aₙ(t) emitted by accelerometers Aₙ, processing means 23 coupled with signal input interface 21 to receive and process the acceleration signals aₙ(t) emitted by accelerometers Aₙ and generate in output a plurality of output signals representative of the state of structure 10 and a signal output interface 22 coupled with processing means 23 to receive the output signals and in signal communication with a remote unit 30 to transmit such output signals to remote unit 30.

In accordance with one embodiment, signal input interface 21 comprises a multi-channel acquisition and analog/digital conversion card with at least 10 bit/channel and frequency fc suitable for the actual frequency of structure 10 for acquiring and sampling acceleration signals aₙ(t) emitted by accelerometers Aₙ.

In accordance with one embodiment, signal output interface 22 comprises a radio mobile communication card, for example UMTS or GPRS, capable of transmitting the output signals to the remote unit 30.

Acquisition unit 20 is arranged near to structure 10, for example at the base of structure 10.

Through signal input interface 21, acquisition unit 20 acquires acceleration signals aₙ(t) emitted by the N accelerometers Aₙ in a first time period Δt₁, in the example comprised between t₀ and t₁, hereafter called first acceleration signals. For example, the three accelerometers A₁,A₂,A₃, over the time period t₀-t₁, emit the first acceleration signals a₁(t), a₂(t) and a₃(t), respectively.

Processing means 23 are suitable for receiving first acceleration signals aₙ(t) and applying, to first acceleration signals aₙ(t), a transformation function in the frequency domain, for example the Fast Fourier transform (FFT), to generate corresponding first frequency signals aₙ(f), for example first frequency signals a₁(f), a₂(f) and a₃(f) representative of the frequency components of relative first acceleration signals a₁(t), a₂(t) and a₃(t).

Processing means 23 are also suitable for detecting the peak of first frequency signals a₁(f), a₂(f) and a₃(f), called first frequency peaks, where the term first frequency peaks indicates a set of N frequencies corresponding to the N frequency peaks present in respective first frequency signals a₁(f), a₂(f) and a₃(f). For example, frequency signal a₁(f) can have a peak at the peak frequencies f₁ and f₂.

For each peak detected in each first frequency signal a₁(f), a₂(f) and a₃(f), processing means 23 are suitable for detecting the temporal variations of the corresponding peak frequency in a predefined range of frequency values over time period t₀-t₁ so as to obtain temporal evolution f(t) of each peak frequency.

For example, taking frequency signal a₁(f) with first peaks on peak frequencies f₁ and f₂, processing means 23 detect the temporal variations of peak frequencies f₁ and f₂ in a predefined range of frequency values Δf so as to obtain temporal evolution f₁(t) and f₂(t) of peak frequencies f₁ and f₂.

Processing means 23 are also suitable for processing the temporal variations of the peak frequencies to calculate, for each of the frequency peaks, an average peak frequency reference value representative of the oscillation frequency of the structure and a respective statistical value representative of the frequency variations with respect to the average peak frequency reference value to define a respective range of frequency values around the average value.

For example, processing means 23 process the temporal variations of peak frequencies f₁ and f₂, i.e. temporal evolution f₁(t) and f₂(t) of peak frequencies f₁ and f₂, to calculate an average peak frequency reference value fmean₁ and fmean₂ and a respective statistical value fvar₁ and fvar₂ to define a respective range of frequency values around the average value.

In order to monitor the state of structure 10, processing means 23 acquire acceleration signals aₙ(t)* emitted by N accelerometers Aₙ in a second time period Δt₂, in the example comprised between t₁ and t₂, subsequent to the first time period Δt₁, hereafter called second acceleration signals. For example, the three accelerometers A₁A₂,A₃ emit, over time period t₁-t₂, second acceleration signals respectively a₁(t)*, a₂(t)* and a₃(t)*.

Second acceleration signals aₙ(t)* are processed by processing means 23 applying a transformation function in the frequency domain, for example the fast Fourier transform (FFT), to generate corresponding second frequency signals a₁(f)*, a₂(f)* and a₃(f)* representative of the frequency components of the relative first acceleration signals a₁(t)*, a₂(t)* and a₃(t)*.

In accordance with one embodiment, the transformation function in the frequency domain applied to second acceleration signals aₙ(t)* corresponds to the transformation function in the frequency domain applied to first acceleration signals aₙ(t). Subsequently, processing means 23 detect, at predetermined time periods Δt, the peak of second frequency signals a₁(f)*, a₂(f)* and a₃(f)*, called second frequency peaks, where the term second frequency peaks indicates a set of M frequencies corresponding to the M frequency peaks present in respective second frequency signals a₁(f)*, a₂(f)* and a₃(f)* and verify, with respect to each calculated average value of the peak frequencies of first frequency signals a₁(f), a₂(f), a₃(f), whether the corresponding peak frequency of the second frequency signal is outside of the respective range of frequency values and generate an error signal sₑᵣᵣ in output as a function of the outcome of such a verification.

Error signal sₑᵣᵣ, received by signal output interface 22, is transmitted to remote unit 30. According to error signal sₑᵣᵣ, technical intervention can be required to check structure 10 or remote unit 30 can send to acquisition and processing unit 20 a request to send the signals processed by processing means 23.

For example, processing means 23 detect, at time periods Δt, peak of frequency f₁* of second frequency signal a₁(f)* and verify, with respect to the average value fmean₁ of peak frequency f₁ of frequency signal a₁(f), whether corresponding peak frequency f₁* of frequency signal a₁(f)* is outside of the respective frequency range and generate an error signal sₑᵣᵣ as a function of the outcome of such a verification.

Basically, processing means 23 verify, at time ranges Δt,

if f₁*<fmean₁−fvar₁ or f₁*>fmean₁+fvar₁ or

if fmean₁−fvar₁≦f₁*≦fmean₁+fvar₁

If the condition

f₁*<fmean₁−fvar₁ or f₁*>fmean₁+fvar₁ is verified

then processing means 23 generate an error signal sₑₙ.

Indeed, in critical conditions, the presence of structural defects determines a reduction of the effective useful section of structure 10 and, consequently, a reduction of its structural rigidity. This reduction determines a consequent reduction of the resonant frequencies of the structure itself and an increase of the intensity of the accelerations detected by accelerometers Aₙ.

In order to minimise the possibility of obtaining false positives, due to exceptional events not possible to be classified as structural defects, like for example snow, ice, weight of the maintenance worker, the value of peak frequency f₁* to compare can be obtained by calculating an average of peak frequency values f₁* over time period t₁-t₂.

In particular, for each peak detected in each second frequency signal a₁(f)*, a₂(f)* and a₃(f)*, processing means 23 detect the temporal variations of the corresponding peak frequency over time period t₁-t₂ to calculate, for each of second frequency peaks, an average peak frequency reference value.

For example, temporal variations f₁(t)* and f₂(t)* of peak frequencies f₁* and f₂* can be processed to calculate an average peak frequency reference value fmean₁* and fmean₂*.

In this case processing means 23 verify, with respect to average value fmean₁ of peak frequency f₁ of frequency signal a₁(f), whether the corresponding average peak frequency reference value fmean₁* of frequency signal a₁(f)* is outside of the respective frequency range and generates an error signal sₑᵣᵣ as a function of the outcome of such a verification.

Basically, processing means 23 verify

if fmean₁*<fmean₁−fvar₁ or fmeans₁*>fmean₁+fvar₁ or

if fmean₁−fvar₁≦fmean₁*≦fmean₁+fvar₁

If the condition

fmean₁*<fmean₁−fvar₁ or fmeans₁*>fmean₁+fvar₁ is verified then processing means 23 generate an error signal sₑᵣᵣ.

In this case, remote unit 30, on receiving error signal sₑᵣᵣ, can send to acquisition and processing unit 20 a request to send temporal variation signal f₁(t)* and f₂(t)* of peak frequencies f₁* and f₂* of second frequency signal a₁(f)*.

In accordance with one embodiment, signal output interface 22 is suitable for transmitting, over a first channel, error signal sₑᵣᵣ and, over a second separate channel, temporal variation signals f₁(t)* and f₂(t)* of peak frequencies f₁* and f₂* of second frequency signals a₁(f)*.

Based upon the temporal evolution of the peak frequencies, an operator can evaluate whether it is necessary for a technical worker to intervene so as to check the structure 10.

In accordance with one embodiment, the average value of the peak frequency values f₁* can be calculated by using a moving average function in which a value at the time i depends upon the value at time i and upon the value at time i−1. For example, a EWMA (Exponentially Weighted Moving Average) function can be used that applies an exponentially decreasing weight over time, to each value at time i−1, so as to consider to a greater extent the most recent values in time without however omitting older values. An example of EWMA function is given by the following relationship:

zᵢ=λ f̅ᵢ+(1−λ)zᵢ₋₁

z₀=μ₀

where
i is the progressive group index (in which each group consists of n individual measurements of peak frequency fᵢ with an average f̅ᵢ,
λ is a constant with 0<λ≦1.

Error signal sₑᵣᵣ is generated each time the value of z, is outside control limits LCLᵢ (Lower Control Limit), UCLᵢ (Upper Control Limit) where

$${LCL}_{i} = {μ}_{0} - L σ \sqrt{\frac{λ}{n ( 2 - λ )} [ 1 - {( 1 - λ )}^{2 i} ]}$$

represents the smallest possible statistical value with the process within the limits,

$${UCL}_{i} = {μ}_{0} + L σ \sqrt{\frac{λ}{n ( 2 - λ )} [ 1 - {( 1 - λ )}^{2 i} ]}$$

represents the greatest possible statistical value with the process within the limits,

where

L is the width of the control limits (typically L=3),
σ is the variance of the measured values fᵢ.

The application of the EWMA function makes it possible to generate a EWMA control card in which there is the temporal evolution of each peak frequency. FIG. 5 shows an example of EWMA control card. In this case, remote unit 30, when it receives error signal sₑᵣᵣ, can send a request to send the values of the EWMA control card to acquisition and processing unit 20.

Since error signal sₑᵣᵣ is generated at structure 10 to be monitored and sent to a remote unit 20 in which the possible processing of the signals processed by processing means 23 occurs, the system and the method of the present invention can be advantageously used for monitoring a plurality of structures to be monitored even spread over vast areas of land. In this way, pluralities of structures to be monitored can be monitored, even simultaneously and continuously.

According to a further aspect, the invention concerns an information technology product that can be directly loaded into the memory of a numerical processing device, comprising portions of program code able to carry out the method of the invention when it is run on the numerical processing device.

As it should be understood from what has been described thus far, the method and the system according to the present invention make it possible to overcome the drawbacks mentioned with reference to the prior art. In this case, the present invention makes it possible to identify, based upon the intrinsic variance of the acquired values, the width of the reference range inside which the measured peak frequencies can be considered “statistically stable”. Such a technique can therefore be applied for monitoring a high number of structures simultaneously, like for example in the case of antenna-carrying pole/trestle systems for mobile telephone communications and poles for wind turbines.

Of course, a man skilled in the art, with the purpose of satisfying contingent and specific needs, may carry out numerous modifications and variants to the method and to the system according to the invention described above, all of which are covered by the scope of protection of the invention as defined by the following claims.

1. Method for monitoring a thin structure, having a constant mass over time and having a first free end and a second opposite end rigidly constrained to a stationary base element, wherein a plurality of accelerometers are associated with said structure, each accelerometer being suitable for emitting an acceleration signal representative of the acceleration detected by the accelerometer, said method comprising the steps of:
a) acquiring first and second acceleration signals emitted by the accelerometers respectively in a first and in a second time period, said second time period following after said first time period,
b) applying a transformation function in the frequency domain to the first and second acceleration signals to generate corresponding first and second frequency signals representative of the frequency components of the relative first and second acceleration signals,
c) detecting first frequency peaks of the first frequency signals, said first frequency peaks representing the frequencies of the frequency peaks of said first frequency signals,
d) detecting the temporal variations of the peak frequencies of each of the first frequency peaks to obtain the temporal .evolution of each of the first frequency peaks,
e) processing said temporal variations of the peak frequencies to calculate, for each of the frequency peaks, an average peak frequency reference value representative of the oscillation frequency of the structure and a respective statistical value representative of the frequency variations with respect to said average peak frequency reference value to define a respective range of frequency values around said average value,
f) detecting, at predetermined time periods, second frequency peaks of the second frequency signals, said second frequency peaks representing the frequencies of the frequency peaks of said second frequency signals,
g) verifying, with respect to each calculated average value of the peak frequencies of the first peak frequency signals, whether the corresponding peak frequency of the second frequency signal is outside of the respective range of frequency values around the respective average value,
h) generating an error signal according to the outcome of said verification step g).

2. Method according to claim 1, wherein said step g) comprises step g1) of calculating the average value of the peak frequency values in said second time period, to obtain said corresponding peak frequency of the second frequency signal.

3. Method according to claim 2, wherein said step g1) comprises the step of detecting, for each peak detected in each second frequency signal, the temporal variations of the corresponding peak frequency in said second time period to calculate, for each of the second frequency peaks, said average value of the peak frequency values in said second time period.

4. Method according to claim 2, wherein said step g) comprises step g2) of verifying, with respect to each calculated average value of the peak frequencies of the first peak frequency signals, whether the corresponding calculated average peak frequency value of the second frequency signal is outside of the respective range of frequency values around the respective average value.

5. Method according to claim 1, wherein in said step g) said corresponding peak frequency of the second frequency signal is calculated through an Exponentially Weighted Moving Average (EWMA) function.

6. System for monitoring a thin structure, having a constant mass over time an having a first free end and a second opposite end rigidly constrained to a stationary base element said system comprising:
a plurality of accelerometers associated with said structure, each accelerometer being suitable for emitting an acceleration signal representative of the acceleration detected by the accelerometer,
an acquisition and processing unit in signal communication with said accelerometers and positioned at the structure to be monitored,
a remote unit in signal communication with said acquisition and processing unit wherein said acquisition and processing unit comprises:
a signal input interface coupled with the accelerometers to receive the acceleration signals emitted by the accelerometers,
processing means coupled with the signal input interface to receive and process the acceleration signals emitted by the accelerometers and generate in output a plurality of output signals representative of the state of the structure,
a signal output interface coupled with the processing means to receive the output signals and in signal communication with said remote unit to transmit said output signals to the remote unit,
wherein said processing means are configured to:
acquire first and second acceleration signals emitted by the accelerometers respectively in a first and in a second time period, said second time period following after said first time period, apply a transformation function in the frequency domain to the first and second acceleration signals to generate corresponding first and second frequency signals representative of the frequency components of the relative first and second acceleration signals,
detect first frequency peaks of the first frequency signals, said first frequency peaks representing the frequencies of the frequency peaks of said first frequency signals,
detect the temporal variations of the peak frequencies of each of the first frequency peaks to obtain the temporal evolution of each of the first frequency peaks,
process said temporal variations of the peak frequencies to calculate, for each of the frequency peaks, an average peak frequency reference value representative of the oscillation frequency of the structure and a respective statistical value representative of the frequency variations with respect to said average peak frequency reference value to define a respective range of frequency values around said average value,
detect, at predetermined time periods, second frequency peaks of the second frequency signals, said second frequency peaks representing the frequencies of the frequency peaks of said second frequency signals, verify, with respect to each calculated average value of the peak frequencies of the first peak frequency signals, whether the corresponding peak frequency of the second frequency signal is outside of the respective range of frequency values around the respective average value,
generate an error signal according to the outcome of said verification step g), wherein said signal output interface being suitable for transmitting said error signal to said remote unit.

7. System according to claim 6, wherein said processing means are configured to calculate the average value of the peak frequency values in said second time period, to obtain said corresponding peak frequency of the second frequency signal.

8. System according to claim 7, wherein said processing means are configured to:
detect, for each peak detected in each second frequency signal, the temporal variations of the corresponding peak frequency in said second time period and
calculate, for each of the second frequency peaks, said average value of the peak frequency values in said second time period.

9. System according to claim 6, wherein said processing means are configured to apply an exponentially weighted moving average (EWMA) function to calculate said corresponding peak frequency of the second frequency signal.
